(19) United States
(12) Patent Application Publication
(10) Pub. No.: US 2025/0031097 A1
(43) Pub. Date: Jan. 23, 2025

(54) EXTENDED REALITY IN WIRELESS COMMUNICATION

(71) Applicant: Lenovo (Singapore) Pte. Limited, Singapore (SG)

(72) Inventors: Joachim Löhr, Wiesbaden (DE); Hossein Bagheri, Urbana, IL (US); Karthikeyan Ganesan, Kronberg Im Taunus (DE); Razvan-Andrei Stoica, Essen (DE); Prateek Basu Mallick, Dreieich (DE)

(73) Assignee: Lenovo (Singapore) Pte. Limited, Singapore (SG)

(21) Appl. No.: 18/776,900

(22) Filed: Jul. 18, 2024

Related U.S. Application Data
(60) Provisional application No. 63/527,705, filed on Jul. 19, 2023.

(51) Int. Cl. H04W 28/08; H04L 69/22; H04W 28/16; H04W 72/1268; H04W 72/56

(52) U.S. Cl. CPC H04W 28/0967; H04L 69/22; H04W 28/16; H04W 72/1268; H04W 72/56

(57) ABSTRACT

Various aspects of the present disclosure relate to extended reality (XR) in wireless communications. For instance, a user equipment (UE) can identify protocol date unit (PDU) sets and associated a PDU set importance (PSI) levels for a tethered XR device (e.g., XR glasses) to assist the UE in quality of service (QoS) fulfillment for XR communications in the uplink. Further, a Layer 2 protocol layer is introduced which can signal PDU set related information via a tethering link from an XR device to a UE. Furthermore, XR related assistance information can be provided via control plane signaling over a sidelink interface to the UE.

### RELATED APPLICATION

This application claims priority to U.S. Provisional Application Ser. No. 63/527,705 filed 19 Jul. 2023 entitled “EXTENDED REALITY IN WIRELESS COMMUNICATION,” the disclosure of which is incorporated by reference herein in its entirety.

### TECHNICAL FIELD

The present disclosure relates to wireless communications, and more specifically to extended reality (XR) in wireless communications.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In XR communication in wireless environments, sharing of data traffic information can be important in tethering scenarios, such as between an XR device and a UE to which the XR device is tethered. Some wireless communications systems, however, may lack the ability to efficiently share data traffic information in such scenarios.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may further include receiving at an XR device and by a first protocol layer, one or more service data units (SDU) from a second protocol layer; implementing one or more headers for the one or more SDU, the one or more headers including one or more fields indicating information related to a protocol data unit (PDU) set associated with the one or more SDU; generating, based at least in part on the one or more SDU, a PDU including an SDU and a corresponding header; and submitting the PDU to a third protocol layer.

In some implementations of the method and apparatuses described herein, the first protocol layer includes an XR application protocol (XRAP) layer; the XRAP layer includes a Layer 2 protocol; the second protocol layer includes a Service Data Application Protocol (SDAP) layer; the third protocol layer includes a packet data convergence protocol (PDCP) layer; the corresponding header includes one or more of a sequence number field, a PDU set sequence number field, a PDU set importance (PSI) field, a PDU set size field, or an indication of end PDU of a PDU set; the corresponding header includes a field indicating timing information of the SDU; the timing information includes an arrival time of the one or more SDU in the first protocol layer; transmitting traffic assistance information to a user equipment (UE) via a PC5 radio resource control (RRC) message; the traffic assistance information includes one or more of burst arrival time information or uplink jitter information.

Some implementations of the method and apparatuses described herein may further include an XR device for wireless communication, including: at least one memory; and at least one processor coupled with the at least one memory and configured to cause the XR device to: receive, by a first protocol layer, one or more SDU from a second protocol layer; implement one or more headers for the one or more SDU, the one or more headers including one or more fields indicating information related to a PDU set associated with the one or more SDU; generate, based at least in part on the one or more SDU, a PDU including an SDU and a corresponding header; and submit the PDU to a third protocol layer.

In some implementations of the method and apparatuses described herein, the first protocol layer includes an XRAP layer; the XRAP layer includes a Layer 2 protocol; the second protocol layer includes a SDAP layer; the third protocol layer includes a PDCP layer; the corresponding header includes one or more of a sequence number field, a PDU set sequence number field, a PSI field, a PDU set size field, or an indication of end PDU of a PDU set; the corresponding header includes a field indicating timing information of the SDU; the timing information includes an arrival time of the one or more SDU in the first protocol layer; the processor is configured to cause the XR device to transmit traffic assistance information to a user equipment (UE) via a PC5 RRC message; the traffic assistance information includes one or more of burst arrival time information or uplink jitter information.

Some implementations of the method and apparatuses described herein may further include generating, by a first protocol layer at a UE, one or more protocol data units (PDU), the one or more PDU including one or more headers and the one or more headers including one or more fields indicating information related to a PDU set associated with the one or more PDU; transmitting, via a second protocol layer, the one or more PDU to an XR device; and receiving, from the XR device, data transmission.

In some implementations of the method and apparatuses described herein, the first protocol layer includes an XRAP layer; the XRAP layer includes a Layer 2 protocol; the second protocol layer includes a SDAP layer; receiving, from the XR device, traffic assistance information via a PC5 RRC message; and transmitting at least a portion of the traffic assistance information to a network entity.

Some implementations of the method and apparatuses described herein may further include a user equipment (UE) device for wireless communication, including: at least one memory; and at least one processor coupled with the at least one memory and configured to cause the UE device to: generate, by a first protocol layer, one or more protocol data units (PDU), the one or more PDU including one or more headers and the one or more headers including one or more fields indicating information related to a PDU set associated with the one or more PDU; transmit, via a second protocol layer, the one or more PDU to an XR device; and receive, from the XR device, data transmission.

In some implementations of the method and apparatuses described herein, the first protocol layer includes an XRAP layer; the XRAP layer includes a Layer 2 protocol; the second protocol layer includes a SDAP layer; receive, from the XR device, traffic assistance information via a PC5 RRC message; and transmit at least a portion of the traffic assistance information to a network entity.

### BRIEF DESCRIPTION OF THE DRAWINGS

FIG. 1 illustrates an example of a wireless communications system in accordance with aspects of the present disclosure.

FIG. 2 illustrates at an example of a PC5 control plane protocol stack.

FIG. 3 illustrates an example implementation scenario in accordance with aspects of the present disclosure.

FIG. 4 illustrates an example of an XR device in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates a flowchart of a method in accordance with aspects of the present disclosure.

FIG. 8 illustrates a flowchart of a method in accordance with aspects of the present disclosure.

### DETAILED DESCRIPTION

In XR communication in wireless communication environments, sharing of data traffic information can be important such as in tethering scenarios between an XR device and a UE. For instance, for XR communication in uplink from an XR device and a UE, such communication may benefit when the UE is able to identify PDU sets and data burst dynamically, including PSI (importance level associated with a PDU set), e.g., for a corresponding discard procedure in PDCP layer. In addition, a UE can provide traffic assistance information (e.g., range of jitter for uplink XR traffic, burst arrival information for a QoS flow and/or uplink (UL) traffic, etc.) to the RAN to assist in efficient delay aware scheduling. In implementations data burst is a set of multiple PDUs generated and sent by the application in a short period of time, as defined in TS 23.501. In scenarios where an XR application resides in a UE, PDU set related information can be provided to the AS of the UE (e.g., PDCP, radio link control (RLC), MAC, etc.) by inter-layer communication. However, in a tethering scenario in some wireless communications systems such as where an XR application, an XR runtime, and/or a display functionality thereof doesn't reside in the UE, traffic related information and/or PDU set related information may not be available in the UE.

Accordingly, the present disclosure provides solutions to enable traffic assistance information to be shared in XR tethering scenarios. For instance, a UE can be able to identify PDU sets and associated PSI levels for a tethered XR device (e.g., XR glasses) to enable the UE in QoS fulfillment for XR communications in the uplink. Further, a Layer 2 protocol layer is introduced which can signal PDU set related information via a tethering link from an XR device to a UE. Furthermore, XR related assistance information is provided via control plane signaling over the sidelink interface to the UE.

In implementations, PDU set related information associated with PDU of a PDU set can be transmitted from an XR device (e.g. XR glasses) to a UE over the PC5 interface/tethering link. The XR device can identify PDUs that belong to PDU sets and determine corresponding PDU set information which the XR device can send to the UE as part of a Layer 2 protocol. Accordingly, a new Layer 2 protocol can be used for the transmission of the PDU set related information, which is referred to herein as XR application layer (XRAP). The XRAP sublayer over PC5 hop can be used for signaling the PDU set information to a UE. For instance, an XRAP header can be present over the PC5 link for the transmission of PDU set related information from the XR device to the UE.

Further, an XR device can provide traffic assistance information to a UE which connects the XR device via a tethering link with the gNB, such as via a sidelink channel. In one example a new PC5-RRC message can be used to transmit the traffic assistance information to the UE. For instance, the XR device can transmit traffic assistance information (e.g., burst arrival time, uplink jitter, etc.) to the UE within a PC5-RRC message. According to at least one implementation sidelink (SL)-SRB3 can be used to transmit the new PC5-RRC message which can be protected and sent after PC5-S security has been established.

It should be noted that the described solutions for signaling PDU set related information and/or traffic assistance information over the tethering link is limited to a PC5 interface/sidelink interface as the tethering link. The disclosed solutions should be generally applicably to any communication technology used on the tethering link.

Accordingly, the present disclosure describes ways to decrease data latency and increase signal quality in XR communication scenarios, such as in tethering scenarios between an XR device and a UE.

Aspects of the present disclosure are described in the context of a wireless communications system.

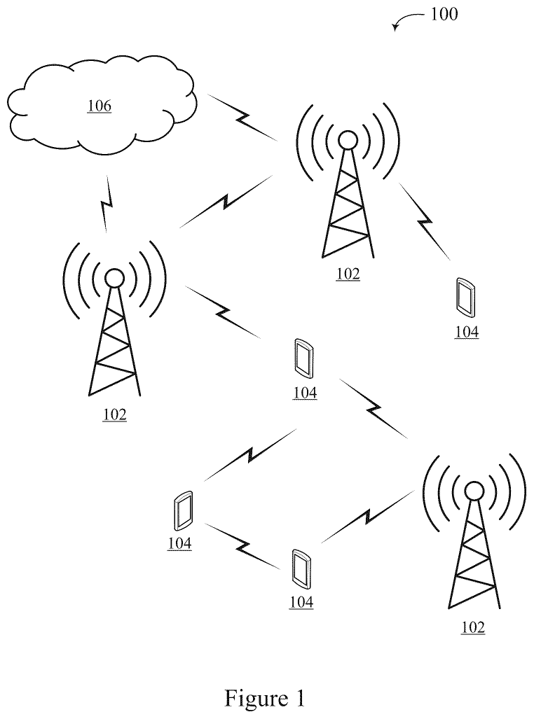

FIG. 1 illustrates an example of a wireless communications system 100 in accordance with aspects of the present disclosure. The wireless communications system 100 may include one or more network elements (NE) 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a PDU session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NE 102 and the UE 104 are operable to implement various aspects of the techniques described with reference to the present disclosure. For example, a UE 104 can establish a wireless tethering connection with an XR device and communicate data from a NE 102 to the XR device via the tethering connection. Further, using the described protocols, the UE 104 can optimize wireless data communication between the NE 102 and the XR device.

In wireless communications systems, XR may be used as an umbrella term for different types of realities including:

Virtual reality (VR) can represent a rendered version of a delivered visual and audio scene. Rendering in VR can be designed to mimic visual and audio sensory stimuli of the real world to an observer or user as they move within an environment defined by an application. Virtual reality can involve a user wearing a head mounted display (HMD) to replace the user's field of view with a simulated visual component and wearing headphones to provide the user with accompanying audio. Head and motion tracking of the user in VR can be implemented to allow simulated visual and audio components to be updated to enable visual items and sound sources remain consistent with the user's movements. Additional means to interact with the virtual reality simulation may also be provided.

Augmented reality (AR) can be used to represent scenarios where a user is provided with additional information and/or artificially generated items or content overlaid upon a current environment. Such additional information and/or content can be visual and/or audible and the user's observation of their current environment may be direct (e.g., with no intermediate sensing, processing and rendering) or indirect where the user's perception of their environment is relayed via sensors and may be enhanced or processed.

Mixed reality (MR) can be used to represent an advanced form of AR where some virtual elements are inserted into the physical scene with the intent to provide the illusion that these elements are part of the real scene.

Further, XR can refer to real and virtual combined environments and human-machine interactions generated by computer technology and wearables. XR can include representative forms such as AR, MR, and VR, and interpolations among them. Levels of virtuality can range from partial sensory inputs to fully immersive VR. XR can involve the extension of human experiences especially relating to the senses of existence (e.g., as represented by VR) and the acquisition of cognition, e.g., as represented by AR.

In scenarios, XR and cloud gaming use cases can be characterized by quasi-periodic traffic (e.g., with possible jitter) with high data rate in downlink (e.g., video steam) combined with frequent UL (e.g., pose/control update) and/or UL video stream. Both downlink and UL traffic can be characterized by relatively strict packet delay budget (PDB).

A set of XR and cloud gaming services can have characteristics of data streams (e.g., video) which may change on-the-fly while the services are running over NR. Therefore, additional information on the running services from higher layers (e.g., QoS flow association, frame-level QoS, application date unit (ADU)-based QoS, XR specific QoS etc.) may be beneficial to facilitate informed choices of radio parameters. Thus XR application awareness by UE and gNB may improve the user experience, improve the NR system capacity in supporting XR services, and reduce the UE power consumption.

An ADU can be considered a smallest unit of data which can be processed independently by an application, such as processing for handling out-of-order traffic data. Further, a video frame can be an I-frame, P-frame, and/or can be composed of I-slices and/or P-slices. I-frames/I-slices can be more important and larger than P-frames/P-slices. An ADU can be one or more I-slices, P-slices, I-frame, P-frame, or combinations thereof. An ADU may be referred to in a networking context as a PDU Set whereby an ADU is mapped to one or more Protocol Data Units (PDUs) forming the corresponding PDU set. Such PDU sets may be represented as Internet Protocol (IP) PDUs carrying the corresponding ADUs.

A service-oriented design considering XR traffic characteristics (e.g., (a) variable packet arrival rate: packets coming at 30-120 frames/second with some jitter, (b) packets having variable and large packet size, (c) B/P-frames being dependent on I-frames, (d) presence of multiple traffic/data flows such as pose and video scene in uplink) can enable more efficient (e.g., in terms of satisfying XR service requirements for a greater number of UEs, or in terms of UE power saving) XR service delivery.

In XR scenarios XR services XR awareness can consider QoS flows, PDU sets, data bursts, and traffic assistance information. Further, PDU set QoS parameters may be provided by a session management function (SMF) to a gNB as part of a QoS profile of a QoS flow. For instance:

PDU Set Delay Budget (PSDB): Such as defined in technical specification (TS) 23.501, upper bound for a duration between a reception time of a first PDU (e.g., at the UPF for downlink, at the UE for UL) and a time when PDU of a PDU set have been successfully received, e.g., at the UE in downlink, at the UPF in UL. A QoS flow may be associated with one PSDB, and when available, a QoS flow applies to both downlink and UL and can supersede the PDB of the QoS flow.

PDU Set Error Rate (PSER): Such as defined in TS 23.501 [3], upper bound for a rate of non-congestion related PDU set losses between RAN and the UE. A QoS flow can be associated with one PSER, and when available, a QoS flow can apply to both downlink and UL and supersede the packet error rate (PER) of the QoS flow.

PDU Set Integrated Handling Information (PSIHI): indicates whether PDU of a PDU set are needed for the usage of PDU set by application layer, such as defined in TS 23.501.

In addition, the UPF can identify PDU that belong to PDU sets and may determine the following PDU Set Information which the UPF can send to a gNB in a GPRS Tunneling Protocol (GTP)-U header:
PDU Set Sequence Number;
Indication of End PDU of the PDU Set;
PDU Sequence Number within a PDU Set;
PDU Set Size in bytes;
PSI, which identifies the relative importance of a PDU Set compared to other PDU Sets within the same QoS Flow.

Traffic assistance information may also be provided by 5GC to the gNB:
Via time sensitive communication information (TSCAI):
UL and/or downlink Periodicity;
N6 Jitter Information (e.g., between UPF and data network) associated with the downlink periodicity.
Indication of end of data burst in the GTP-U header of a last PDU in downlink.
In the uplink, the UE can identify PDU sets and data bursts dynamically, including PSI.

According to aspects of the present disclosure, a first node (e.g., a first device) provides traffic assistance information to a second node (e.g., a second device) via a sidelink channel. According to at least one implementation the first node is an XR device (e.g. XR glasses) and the second node is a UE, e.g., a mobile phone. In at least one example an XR application resides in the first node and provides XR traffic assistance information to the second node.

In implementations an XR device may be tethered through 5G connectivity (e.g. sidelink) to a UE. Further, for XR communication in uplink, the UE can identify PDU sets and data burst dynamically, including PSI (e.g., importance level associated with a PDU set), such as for a corresponding discard procedure in PDCP layer. In addition, a UE can provide traffic assistance information (e.g., range of jitter for UL (e.g., XR) traffic, burst arrival information for a QoS flow and/or UL traffic, etc.) to a RAN to assist in efficient delay aware scheduling. In scenarios where an XR application resides in the UE (e.g. an application layer is in the UE) the PDU set related information (e.g., identification of PDU sets, data bursts, PSI, etc.) can be provided to the AS layer of the UE (e.g., Layer 2 protocol layers like PDCP/RLC/MAC) by inter-layer communication. In implementations how such information is provided to the AS of the UE can be based on UE implementation. In a tethering scenario, where an XR application, XR runtime, and/or a display/recording functionality thereof, doesn't reside on the UE, the traffic related information as well as the PDU set related information can be signaled via the tethering link to the UE.

In implementations a new PC5-RRC message can be used to transmit traffic assistance information to the UE. For instance, an XR device such as XR glasses can transmit traffic assistance information (e.g., burst arrival time, UL jitter, etc.) to a UE within a PC5-RRC message. According to at least one implementation SL-SRB3 can be used to transmit the new PC5-RRC message, which can be protected and sent after PC5-S security has been established. In at least one example XR assistance information (e.g., jitter information, burst arrival time, etc.) can be transmitted as part of sidelink assistance information transmitted between UE having an established unicast connection. For instance, sidelink assistance information may include sidelink (SL) discontinuous reception (DRX) configuration.

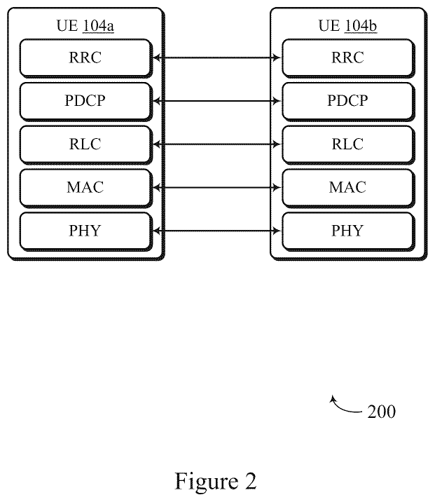

FIG. 2 illustrates at 200 an example of a PC5 control plane protocol stack. The illustrated PC5 protocol stack at 200, for instance, includes communication between a UE 104a and a UE 104b.

In implementations, jitter information provided within assistance information from a first node (e.g., XR device) to a second node (e.g., UE) via a PC5 interface can compensate for delay variance contributed by sidelink transmissions. For instance, a sidelink and/or PC5 link can increase jitter, and thus the provided jitter information can include a jitter portion contributed by the sidelink and/or PC5 interface.

In implementations a network can configure whether XR traffic assistance information is to be reported over the sidelink interface. In at least one example the assistance information can be reported per QoS flow. Further, a network can configure for which QoS flows an XR device is to report assistance information to a UE.

In implementations PDU set related information associated with PDU of a PDU set can be transmitted from a first device (e.g., an XR device) to a second device (e.g., a UE such as a mobile phone) over the PC5 interface. According to at least one implementation, a sidelink Tx UE can identify PDU that belong to PDU sets and determine corresponding PDU set information. The sidelink Tx UE can send PDU set information to an Rx UE as part of a Layer 2 protocol. In at least one example the Tx UE can be a XR device (e.g., XR glasses) which is connected to a gNB via a tethering link, e.g., sidelink and/or PC5 interface. In implementations where an XR application, XR runtime, and/or a display/recording functionality thereof does not reside in a UE, the PDU set related information can be signaled from the XR device via the tethering link to the UE. In at least one example PDU set related information which is signaled via sidelink to the UE can include one or more of the following:
PDU Set Sequence Number;
Indication of End PDU of the PDU Set;
PDU Sequence Number within a PDU Set;
PDU Set Size in bytes;
PSI which can identify the relative importance of a PDU Set compared to other PDU Sets within the same QoS Flow;
Indication of an End of Data Burst.

In implementations a new Layer 2 protocol can be used for the transmission of the PDU set related information. In the following the new Layer 2 protocol layer is referred to as XR application layer (XRAP).

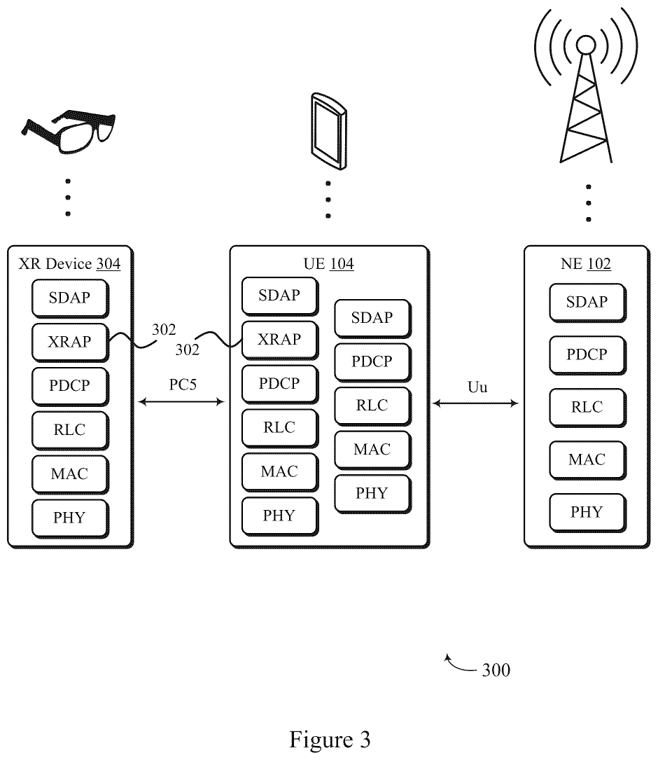

FIG. 3 illustrates an example implementation scenario 300 in accordance with aspects of the present disclosure. The scenario 300, for instance, represents a UP protocol stack for a tethering scenario. In the scenario 300 an XRAP sublayer 302 is placed above PDCP layer and below SDAP layer in an XR device 304 (e.g., XR glasses) and a UE 104, respectively. In implementations the XRAP layer 302 is implemented at the UP at the PC5 interface and is terminated at the UE 104, e.g., at the link between XR device 304 and the UE 104. The XRAP sublayer 302 over PC5 hop can be used for signaling PDU set information to the UE 104, e.g., an XRAP header is present over the PC5 link for the transmission of PDU set related information from the XR device 304 to the UE 104. Similar to the UPF which can add PDU set info into the GTP-U headers of downlink packets to assist a RAN for PDU set integrated QoS handling, the XR device 304 can add PDU set info into an XRAP header to provide the UE 104 with information for PDU set related layer procedures, e.g., PDU set discarding (e.g., based on PSI) and delay status reporting (DSR) within the buffer status reporting procedure. PDU set information can be provided by the Application Layer to the XRAP 302.

In implementations PDU set related information can be transmitted within a header of an existing Layer 2 protocol (e.g., PDCP header) over the PC5 interface from the XR device 304 to the UE. For instance, the UE 104 (e.g., sidelink Rx device) in a tethering scenario extracts the PDU set related information (e.g. as part of the XRAP protocol functionality) and uses the information to perform corresponding XR specific procedures. Examples of XR specific procedures, for instance, include discarding a PDU set (e.g., taking into account the PSI associated with a PDU set in case of congestion) and/or delay information reporting for a XR buffer status report (BSR). In implementations, the UE 104 can receive PDU set related information on a Layer 2 protocol over the PC5 interface (e.g., the XRAP layer 302) and can use this information for the corresponding XR related procedures.

In implementations timing information of PDU set related information can be transmitted from a first device (e.g., XR device) to a second device (e.g., UE) over the PC5 interface. The timing information, for instance, can include information related to the arrival time of a PDU of a PDU set at the AS, e.g. XRAP/PDCP layer. According to an implementation, the timing information includes a time stamp denoting the arrival time of a PDU of a PDU set at the AS. In at least one example the timing information (e.g., time stamp) is transmitted within a Layer 2 protocol header. In at least one example the time stamp is included in a XRAP header.

In implementations the timing information (e.g., time stamp) can be transmitted for the first PDU of a PDU set, e.g., within the XRAP header. For the enforcement of a PDU set delay budget (PSDB) on the air interface the arrival of the first PDU of a PDU set can be important. For instance, PDU set related discard timer is considered as expired based on the expiry of the PDCP discard timer associated with the first PDU of a PDU set. Thus it can be important to track the delay status of the first PDU of a PDU set. Further, for the delay status reporting (DSR), the delay status of a PDU set can be determined based on the delay status of the first PDU of a PDU set arrived at the L2 buffer. In implementations timing information (e.g., time stamps, delay status reports, etc.) are present correspondingly in each PDU of a PDU set such as to enable further network-driven analytics of sidelink timing and delay conditions.

In implementations, after reception of a PDU being part of a PDU set and reception of timing information associated with the PDU (e.g., time stamp and/or remaining delay information), a UE can determine an elapsed time since arrival of the PDU and/or PDU set in the XR device, e.g., AS of the XR glasses. In one example the UE can set a PDCP discard timer associated with the PDU accordingly taking into account the already elapsed time and can start the timer. The UE, for instance, accounts for the already elapsed time before arriving at the PDCP layer at the UE when setting and/or starting the corresponding PDCP discard timer. For example if the PDCP discard timer of a XR logical channel (LCH) and/or PDCP entity is configured by the network to 20 ms and the PDU when arriving at the PDCP layer of the UE has been already 7 ms in flight (e.g., 7 ms has been elapsed since the PDU has been submitted from the application layer (AL) to the PDCP layer in the XR device until the successful reception of the PDU over the PC5 interface at the UE), the PDCP discard timer can be set to 13 ms and started upon the arrival of the PDU at the PDCP layer.

In implementations, end of data burst (EODB) information can be included as part of PDU set related information transmitted from a first device (e.g., XR device) to a second device (e.g., UE) over the PC5 interface, e.g., XR glasses can provide EODB information to a UE. The EODB information may be used by the UE to determine unused resource indication within the configured grant (CG) uplink control information (UCI) sent on a CG physical uplink shared channel (PUSCH) resource, e.g., unused transmission opportunities uplink control information (UTO-UCI). UTO-UCI, for instance, indicates unused transmission opportunities (e.g., unused CG PUSCH resources) and can be used as control signaling for XR communications.

Further, for DRX operation the EODB information can be beneficial from a UE power saving perspective, e.g., a UE can transition to sleep mode after EODB indication until a start of the next data burst, such as determined by the periodicity and/or explicitly signaled.

In some scenarios jitter may be introduced due to the additional tethering link (e.g., PC5 interface) and thus EODB indication on the sidelink PC5 interface can be beneficial. For instance, a UE may trigger an empty BSR on the Uu interface based on the EODB indication received over the sidelink and/or PC5 interface. An empty BSR, for example, can be reported to the gNB to provide information about the EODB. In implementations an EODB indication can be signaled within a Layer 2 protocol header. In at least one example the EODB indication can be signaled within an XRAP header and/or alternative PDCP header. Additionally or alternatively, the EODB indication can be transmitted within a new sidelink medium access control (MAC) control element (CE).

In implementations XR-related sidelink assistance information can be provided from a first device to a second device over the PC5 interface. In at least one implementation the first device is an XR device (e.g., XR glasses) and the second device is a UE, e.g. NR UE. According to at least one implementation, the XR-related sidelink assistance information is provided via a new sidelink MAC CE from the XR glasses to the UE. For instance, the XR-related assistance information can include buffer status information and delay information associated with the reported buffer status information, e.g. delay information about buffered data such as indicating remaining time.

In at least one example the XR device can transmit the new SL assistance information MAC CE together with a first PDU of a PDU set. The new MAC CE, for instance, can be triggered with the arrival of new data for a logical channel, e.g., a first PDU of a PDU set for a XR LCH. Sidelink buffer status information included within the new SL MAC CE can include an amount of data of a complete PDU set, e.g., the AL can inform the AS about a size of the PDU set such as an amount of bytes. A UE upon reception of the sidelink buffer status information can request UL resources, such as by triggering a SR and/or BSR for the transmission of the PDU set. Early buffer status information can shorten the overall delay and assist with transmitting the PDU set within its associated PSDB.

In implementations a new timer can be configured which controls the latency requirement associated with the new SL MAC CE. For instance, content of the new SL MAC CE (e.g., buffer status information and/or delay status information associated with the buffered data) may have a limited validity time, and thus the MAC CE may have an associated latency requirement. For instance, the SL MAC CE is to be transmitted to the Rx device (e.g., UE) before the content of the MAC CE is outdated, and thus the Tx device (e.g., XR glasses) can start the new timer when transmission of the SL MAC CE has been triggered. If the timer expires before the transmission of the MAC CE, the UE can according to at least one implementation cancel the triggered SL MAC CE assistance information reporting.

In at least one example if an XR device is configured with sidelink resource allocation Mode 1, the XR device can trigger a scheduling request for scenarios where the SL MAC CE assistance information reporting has been triggered and the XR device has no valid SL resource.

In implementations a first device can send a PDCP discard timer configuration for a sidelink radio bearer (SLRB) and/or PDCP entity to a second device over the PC5 interface. The first device, for instance, is a UE which is connected to a gNB via NR Uu interface and connected to the second device (e.g., XR glasses) via a PC5 interface. The UE can receive in one example the PDCP discard timer configuration from the gNB for the Uu radio bearer. The gNB, for instance, configures the PDCP discard timer values for the XR bearer based on the PSDB value provided by the SMF to the gNB as part of the QoS profile of a QoS flow when a QoS Flow is enabled with PDU set based QoS handling by 5GC. Accordingly the UE can signal the PDCP discard timer configuration for the SLRB/PDCP entity which is mapped to and/or associated with the Uu radio bearer to the XR device.

In implementations a UE can inform a gNB about the CG configuration and/or CG transmission occasions (e.g. timing of the SL CG occasions) on the PC5 sidelink interface to align the SL CG occasions associated with a XR bearer/LCH with the corresponding CG occasions on the Uu interface, e.g., CG PUSCH occasions. In at least one example the SL CG configuration/timing information can be transmitted as part of UE assistance information to the gNB. Alternatively or additionally the assistance information can be transmitted via RRC signaling.

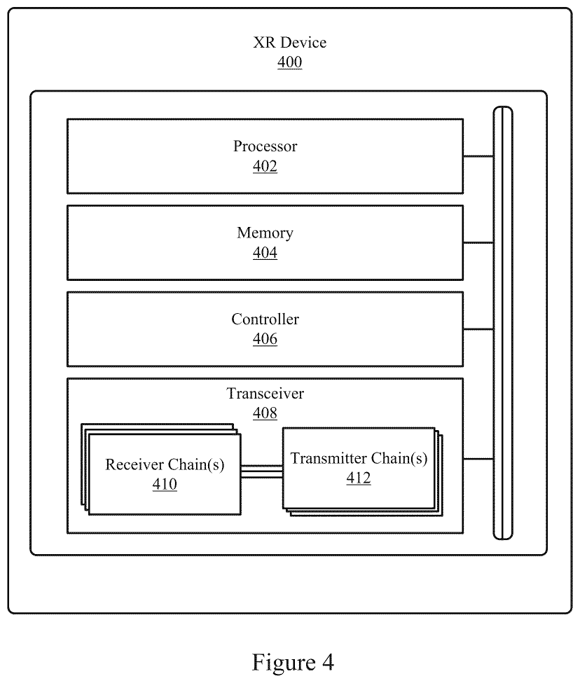

FIG. 4 illustrates an example of an XR device 400 in accordance with aspects of the present disclosure. The XR device 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the XR device 400 to perform various functions of the present disclosure.

The memory 404 may include volatile or non-volatile memory. The memory 404 may store computer-readable, computer-executable code including instructions when executed by the processor 402 cause the XR device 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the XR device 400 to perform one or more of the functions described herein (e.g., executing, by the processor 402, instructions stored in the memory 404). For example, the processor 402 may support wireless communication at the XR device 400 in accordance with examples as disclosed herein. The XR device 400 may be configured to or operable to support a means for receiving, by a first protocol layer, one or more SDU from a second protocol layer; implementing one or more headers for the one or more SDU, the one or more headers including one or more fields indicating information related to a PDU set associated with the one or more SDU; generating, based at least in part on the one or more SDU, a PDU including an SDU and a corresponding header; and submitting the PDU to a third protocol layer.

Additionally, the XR device 400 may be configured to support any one or combination of where the first protocol layer includes an XRAP layer; the XRAP layer includes a Layer 2 protocol; the second protocol layer includes a SDAP layer; the third protocol layer includes a PDCP layer; the corresponding header includes one or more of a sequence number field, a PDU set sequence number field, a PSI field, a PDU set size field, or an indication of end PDU of a PDU set; the corresponding header includes a field indicating timing information of the SDU; the timing information includes an arrival time of the one or more SDU in the first protocol layer; transmitting traffic assistance information to a user equipment (UE) via a PC5 RRC message; the traffic assistance information includes one or more of burst arrival time information or uplink jitter information.

Additionally, or alternatively, the XR device 400 may support to receive, by a first protocol layer, one or more SDU from a second protocol layer; implement one or more headers for the one or more SDU, the one or more headers including one or more fields indicating information related to a PDU set associated with the one or more SDU; generate, based at least in part on the one or more SDU, a PDU including an SDU and a corresponding header; and submit the PDU to a third protocol layer.

Additionally, the XR device 400 may be configured to support any one or combination of where the first protocol layer includes an XRAP layer; the XRAP layer includes a Layer 2 protocol; the second protocol layer includes a SDAP layer; the third protocol layer includes a PDCP layer; the corresponding header includes one or more of a sequence number field, a PDU set sequence number field, a PSI field, a PDU set size field, or an indication of end PDU of a PDU set; the corresponding header includes a field indicating timing information of the SDU; the timing information includes an arrival time of the one or more SDU in the first protocol layer; the processor is configured to cause the XR device to transmit traffic assistance information to a user equipment (UE) via a PC5 RRC message; the traffic assistance information includes one or more of burst arrival time information or uplink jitter information.

The controller 406 may manage input and output signals for the XR device 400. The controller 406 may also manage peripherals not integrated into the XR device 400. In some implementations, the controller 406 may utilize an operating system such as iOS®, ANDROID®, WINDOWS®, or other operating systems. In some implementations, the controller 406 may be implemented as part of the processor 402.

In some implementations, the XR device 400 may include at least one transceiver 408. In some other implementations, the XR device 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

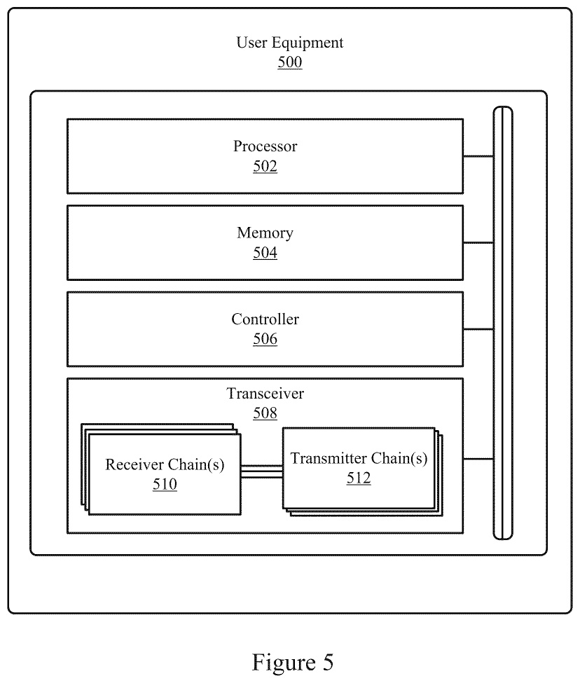

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for generating, by a first protocol layer, one or more protocol data units (PDU), the one or more PDU including one or more headers and the one or more headers including one or more fields indicating information related to a PDU set associated with the one or more PDU; transmitting, via a second protocol layer, the one or more PDU to an XR device; and receiving, from the XR device, data transmission.

Additionally, the UE 500 may be configured to support any one or combination of where the first protocol layer includes an XRAP layer; the XRAP layer includes a Layer 2 protocol; the second protocol layer includes a SDAP layer; receiving, from the XR device, traffic assistance information via a PC5 RRC message; and transmitting at least a portion of the traffic assistance information to a network entity.

Additionally, or alternatively, the UE 500 may support to generate, by a first protocol layer, one or more protocol data units (PDU), the one or more PDU including one or more headers and the one or more headers including one or more fields indicating information related to a PDU set associated with the one or more PDU; transmit, via a second protocol layer, the one or more PDU to an XR device; and receive, from the XR device, data transmission.

Additionally, the UE 500 may be configured to support any one or combination of where the first protocol layer includes an XRAP layer; the XRAP layer includes a Layer 2 protocol; the second protocol layer includes a SDAP layer; receive, from the XR device, traffic assistance information via a PC5 RRC message; and transmit at least a portion of the traffic assistance information to a network entity.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as AM, frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

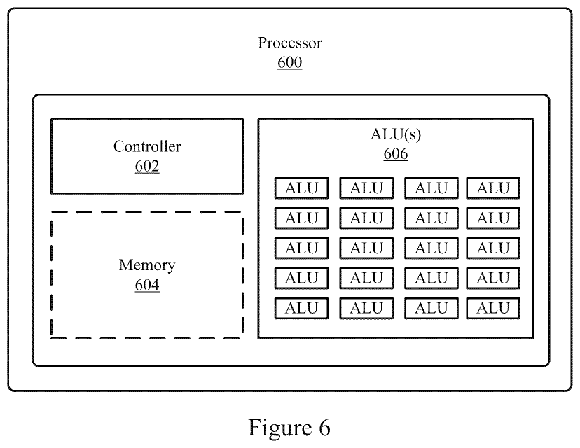

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to receive, by a first protocol layer, one or more SDU from a second protocol layer; implement one or more headers for the one or more SDU, the one or more headers including one or more fields indicating information related to a PDU set associated with the one or more SDU; generate, based at least in part on the one or more SDU, a PDU including an SDU and a corresponding header; and submit the PDU to a third protocol layer.

Additionally, the processor 600 may be configured to support any one or combination of where the first protocol layer includes an XRAP layer; the XRAP layer includes a Layer 2 protocol; the second protocol layer includes a SDAP layer; the third protocol layer includes a PDCP layer; the corresponding header includes one or more of a sequence number field, a PDU set sequence number field, a PSI field, a PDU set size field, or an indication of end PDU of a PDU set; the corresponding header includes a field indicating timing information of the SDU; the timing information includes an arrival time of the one or more SDU in the first protocol layer; the processor is configured to cause the XR device to transmit traffic assistance information to a user equipment (UE) via a PC5 RRC message; the traffic assistance information includes one or more of burst arrival time information or uplink jitter information

The processor 600 may support wireless communication in accordance with examples as disclosed herein. The processor 600 may be configured to or operable to generate, by a first protocol layer, one or more protocol data units (PDU), the one or more PDU including one or more headers and the one or more headers including one or more fields indicating information related to a PDU set associated with the one or more PDU; transmit, via a second protocol layer, the one or more PDU to an XR device; and receive, from the XR device, data transmission.

Additionally, the processor 600 may be configured to support any one or combination of where the first protocol layer includes an XRAP layer; the XRAP layer includes a Layer 2 protocol; the second protocol layer includes a SDAP layer; receive, from the XR device, traffic assistance information via a PC5 RRC message; and transmit at least a portion of the traffic assistance information to a network entity.

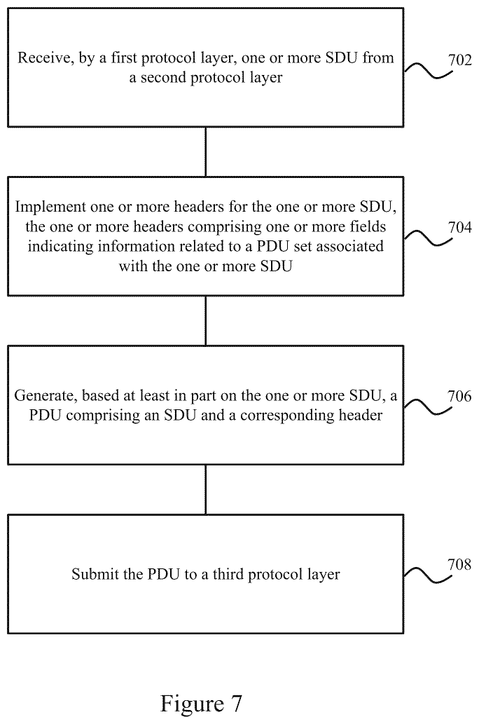

FIG. 7 illustrates a flowchart of a method in accordance with aspects of the present disclosure. The operations of the method may be implemented by an XR device as described herein. In some implementations, the XR device may execute a set of instructions to control the function elements of the XR device to perform the described functions.

At 702, the method may include receiving, by a first protocol layer, one or more SDU from a second protocol layer. The operations of 702 may be performed in accordance with examples as described herein. In some implementations, aspects of the operations of 702 may be performed by a XR device as described with reference to FIG. 4.

At 704, the method may include implementing one or more headers for the one or more SDU, the one or more headers comprising one or more fields indicating information related to a PDU set associated with the one or more SDU. The operations of 704 may be performed in accordance with examples as described herein. In some implementations, aspects of the operations of 704 may be performed by a XR device as described with reference to FIG. 4.

At 706, the method may include generating, based at least in part on the one or more SDU, a PDU comprising an SDU and a corresponding header. The operations of 706 may be performed in accordance with examples as described herein. In some implementations, aspects of the operations of 706 may be performed a XR device as described with reference FIG. 4.

At 708, the method may include submitting the PDU to a third protocol layer. The operations of 708 may be performed in accordance with examples as described herein. In some implementations, aspects of the operations of 708 may be performed a XR device as described with reference FIG. 4

It should be noted that the method described herein describes a possible implementation, and that the operations and the steps may be rearranged or otherwise modified and that other implementations are possible.

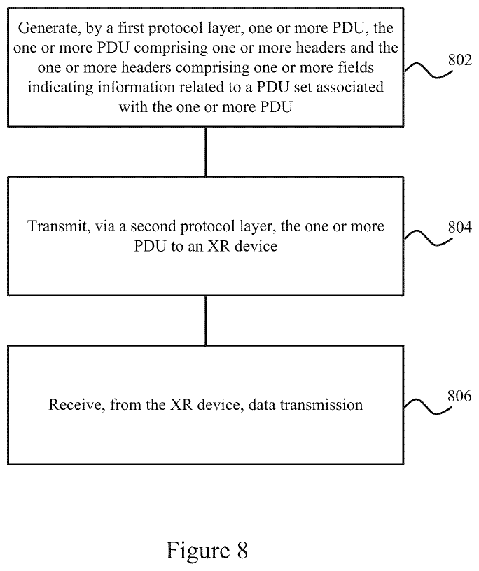

FIG. 8 illustrates a flowchart of a method in accordance with aspects of the present disclosure. The operations of the method may be implemented by a UE as described herein. In some implementations, the UE may execute a set of instructions to control the function elements of the UE to perform the described functions.

At 802, the method may include generating, by a first protocol layer, one or more PDU, the one or more PDU comprising one or more headers and the one or more headers comprising one or more fields indicating information related to a PDU set associated with the one or more PDU. The operations of 802 may be performed in accordance with examples as described herein. In some implementations, aspects of the operations of 802 may be performed by a UE as described with reference to FIG. 5.

At 804, the method may include transmitting, via a second protocol layer, the one or more PDU to an XR device. The operations of 804 may be performed in accordance with examples as described herein. In some implementations, aspects of the operations of 804 may be performed by a UE as described with reference to FIG. 5.

At 806, the method may include receiving, from the XR device, data transmission. The operations of 806 may be performed in accordance with examples as described herein. In some implementations, aspects of the operations of 806 may be performed a UE as described with reference to FIG. 5.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An extended reality (XR) device for wireless communication, comprising:
at least one memory; and
at least one processor coupled with the at least one memory and configured to cause the XR device to:
receive, by a first protocol layer, one or more service data units (SDU) from a second protocol layer;
implement one or more headers for the one or more SDU, the one or more headers comprising one or more fields indicating information related to a protocol data unit (PDU) set associated with the one or more SDU;
generate, based at least in part on the one or more SDU, a PDU comprising an SDU and a corresponding header; and
submit the PDU to a third protocol layer.

2. The XR device of claim 1, wherein the first protocol layer comprises an extended reality (XR) application protocol (XRAP) layer.

3. The XR device of claim 2, wherein the XRAP layer comprises a Layer 2 protocol.

4. The XR device of claim 1, wherein the second protocol layer comprises a Service Data Application Protocol (SDAP) layer.

5. The XR device of claim 1, wherein the third protocol layer comprises a packet data convergence protocol (PDCP) layer.

6. The XR device of claim 1, wherein the corresponding header comprises one or more of a sequence number field, a PDU set sequence number field, a PDU set importance (PSI) field, a PDU set size field, or an indication of end PDU of a PDU set.

7. The XR device of claim 1, wherein the corresponding header comprises a field indicating timing information of the SDU.

8. The XR device of claim 7, wherein the timing information comprises an arrival time of the one or more SDU in the first protocol layer.

9. The XR device of claim 1, wherein the processor is configured to cause the XR device to transmit traffic assistance information to a user equipment (UE) via a PC5 radio resource control (RRC) message.

10. The XR device of claim 9, wherein the traffic assistance information comprises one or more of burst arrival time information or uplink jitter information.

11. A user equipment (UE) device for wireless communication, comprising:
at least one memory; and
at least one processor coupled with the at least one memory and configured to cause the UE device to:
generate, by a first protocol layer, one or more protocol data units (PDU), the one or more PDU comprising one or more headers and the one or more headers comprising one or more fields indicating information related to a protocol data unit (PDU) set associated with the one or more PDU;
transmit, via a second protocol layer, the one or more PDU to an extended reality (XR) device; and
receive, from the XR device, data transmission.

12. The UE of claim 11, wherein the first protocol layer comprises an extended reality (XR) application protocol (XRAP) layer.

13. The UE of claim 12, wherein the XRAP layer comprises a Layer 2 protocol.

14. The UE of claim 11, wherein the second protocol layer comprises a Service Data Application Protocol (SDAP) layer.

15. The UE of claim 11, wherein the processor is configured to cause the UE to:
receive, from the XR device, traffic assistance information via a PC5 radio resource control (RRC) message; and
transmit at least a portion of the traffic assistance information to a network entity.

16. A processor for wireless communication, comprising:
at least one controller coupled with at least one memory and configured to cause the processor to:
receive, by a first protocol layer, one or more service data units (SDU) from a second protocol layer;
implement one or more headers for the one or more SDU, the one or more headers comprising one or more fields indicating information related to a protocol data unit (PDU) set associated with the one or more SDU;
generate, based at least in part on the one or more SDU, a PDU comprising an SDU and a corresponding header; and
submit the PDU to a third protocol layer.

17. The processor of claim 16, wherein the first protocol layer comprises an extended reality (XR) application protocol (XRAP) layer.

18. The processor of claim 17, wherein the XRAP layer comprises a Layer 2 protocol.

19. The processor of claim 16, wherein the second protocol layer comprises a Service Data Application Protocol (SDAP) layer.

20. A processor for wireless communication, comprising:
at least one controller coupled with at least one memory and configured to cause the processor to:
generate, by a first protocol layer, one or more protocol data units (PDU), the one or more PDU comprising one or more headers and the one or more headers comprising one or more fields indicating information related to a protocol data unit (PDU) set associated with the one or more PDU;
transmit, via a second protocol layer, the one or more PDU to an extended reality (XR) device; and
receive, from the XR device, data transmission.
